(19) United States
(12) Patent Application Publication
(10) Pub. No.: US 2009/0026204 A1
(43) Pub. Date: Jan. 29, 2009

(54) COOKING UTENSIL

(76) Inventor: Peter Ek, Jarfalla (SE)

Correspondence Address: KNOBBE MARTENS OLSON & BEAR LLP, 2040 MAIN STREET, FOURTEENTH FLOOR, IRVINE, CA, 92614, US

(21) Appl. No.: 12/092,680

(22) PCT Filed: Sep. 19, 2007
(86) PCT No.: PCT/SE07/00820

§ 371 Date: Sep. 23, 2008

(30) Foreign Application Priority Data
Nov. 8, 2005 (NO) 20055244

(51) Int. Cl. A47J 36/08

(52) U.S. Cl. 220/318; 210/469; 220/367.1; 220/366.1

(57) ABSTRACT

Cooking pot (1) for preparing food comprising a pot (2) with a circular horizontal cross section and at least one drainage device (3) and at least one handle (4) on the outside of the cooking pot. The cooking pot also comprises a cover (5) with a perpendicular, annular flange (6), the diameter of which is slightly less than the inner diameter of the pot (2). The flange (6) has at least one radially arranged through hole (7), and the cover has at least one handle (8), wherein the through hole (7) is arranged so that when the cover (5) is arranged on the pot (2), the peripheral position of the hole (7) coincides with that of the drainage device (3) when the peripheral positions of the handles (4, 8) on the pot (2) and of the cover (5) coincide with each other and the peripheral position of the hole (7) does not coincide with that of the drainage device (3), when the peripheral positions of the handles (4, 8) on the pot (2) and the cover (5) do not coincide with each other.

The current invention pertains to a cooking pot for preparing food comprising a pot with a circular horizontal cross section and at least one drainage device and at least one handle on the outside of the cooking pot as well as a cover comprising a perpendicular, annular flange, the diameter of which is slightly less than the inner diameter of the pot, a covering part, and at least one handle and which flange has at least one radial through hole, and where the at least one through hole is arranged so that, when the cover is arranged on the pot, the peripheral position of the hole coincides with that of one of at least one drainage device when the peripheral positions of the cover and the handles on the cover coincide with each other and the peripheral position of the hole does not coincide with that of one of at least one drainage device, when the peripheral positions of the pot and the handles on the pot do not coincide with each other.

### BACKGROUND AND STATE OF THE ART

Such pots are previously known by for example U.S. Pat. No. 5,730,045 A, U.S. Pat. No. 5,653,881 A and U.S. Pat. No. 4,310,418 A. These patents describe pots in which it is possible to shift between a drainage position, when the holes in the flange of the cover peripherically coincide with a drainage device in the pot, and a closed position for cooking, when the hole or the holes do not coincide with the drainage device, but are closed towards the inner periphery of the pot. To shift the cover between these positions the upper side of the cover is arranged with a centrally located knob. The two latter patents moreover describe the knob containing information about how to direct the knob for the cover to be in one or the other position, in relation to the drainage device of the pot. From U.S. Pat. No. 2,083,017 it is previously known a cooking pot where also the cover has a handle designed to in its rotational position coincide with the handle of the pot when the cover is in the drainage position.

Despite these solutions, the devices shown are fraught with certain deficiencies. Despite the design of the knobs, they do not contain unequivocal information about how the cover should be turned to be in one or the other position. Furthermore, the frequent problem remains with the cover tending to fall out of the pot when water is to be decanted, if it is not kept in position with the other hand. This is cumbersome since the knob provides the only lock on the cover. With larger pots the pot often have two handles which demand the use of both hands. The only way to hold the cover against the pot is to use the fingers which causes serious risks for burns.

### SUMMARY OF THE INVENTION

One object of the current invention is thus to design a cooking pot with which it is possible to decant water (for example potato water) with one hand without risking the cover falling out.

The current invention is hence characterized in that the handles on the pot are a pair arranged on opposite sides of the periphery of the pot and that the handles on the cover are two handles arranged on opposite sides of the periphery of the cover part.

### BRIEF DESCRIPTION OF THE DRAWINGS

The advantages and characteristics of the invention are in detail better understood by way of the following description of preferred embodiments which refer to the figures that form part of the description, in which

FIG. 1 shows a first embodiment of a cooking pot according to the invention, in its decanting position;

FIG. 2 shows the cooking pot according to the embodiment in FIG. 1 in a closed boiling position;

FIG. 3 shows a second embodiment of a cooking pot according to the invention, in its decanting position;

FIG. 4 shows the cooking pot according to the embodiment in FIG. 4 in a closed boiling position;

FIG. 5 shows a locking lip more in detail, which forms part of a cooking pot according to the invention.

### DETAILED DESCRIPTION OF THE INVENTION

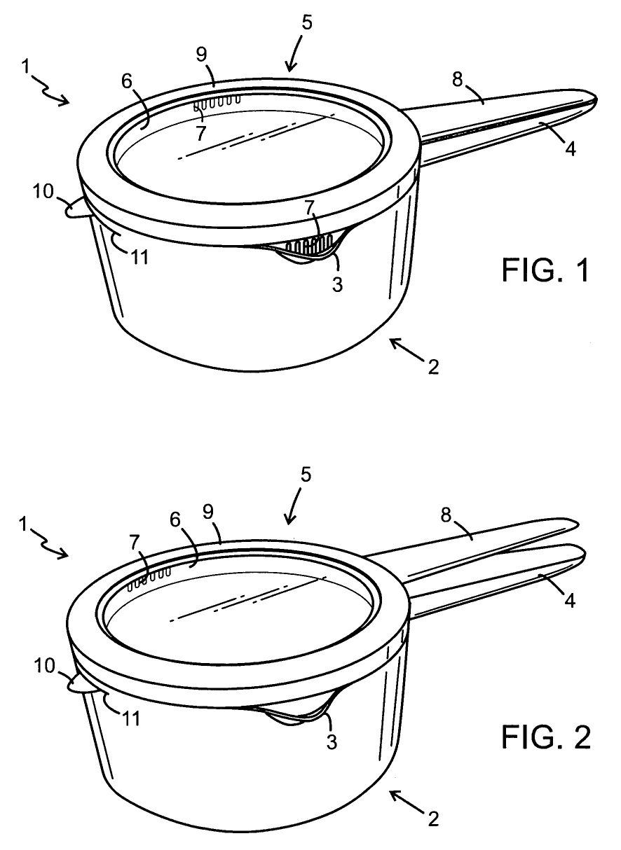

FIG. 1 shows a cooking pot 1 comprising a pot 2 with a circular horizontal cross section and a drainage device 3 in the form of a spout. A second identical drainage device is arranged on the opposite side of the pot, but cannot be seen in the figure. On the outside of the cooking pot a handle 4 is arranged, which is displaced around 90° along the periphery of the pot 2, in relation to the drainage device 3. The cooking pot 1 also comprises a cover 5 comprising a perpendicular, annular flange 6, the diameter of which is slightly less than the inner diameter of the pot 2, and which is intended to be arranged revolving coaxially within the periphery of the pot 1. On the upper side of the flange 6 a covering part 9 is arranged, the diameter of which surpasses the diameter of the pot 2, so that it when the cover 5 is localized on the pot 2, is with its lower side resting on the upper edge of the pot 2. The flange 6 within an area exhibits several radially arranged through holes 7. On the opposite side of the periphery of the flange 6 there is likewise arranged an identical area with several radially arranged through holes. On the shell surface of the cover part 9 a handle 8 is arranged in a position which is displaced around 90° from the area with the through holes 7.

The areas with the radially arranged through holes 7 on the flange 6 are arranged so that, when the cover 5 is arranged on the pot 2 and the cover 5 is turned in relation to the pot 2 so that the handle 8 on the pot 5 and the handle 4 on the pot 2 coincide, the areas with the radially arranged through holes 7 coincide with the positions of the drainage devices 3. It is then possible to decant the fluid that is present in the pot 2 through the radially arranged through holes without losing the solid substance in the pot 2, by taking hold of the two coinciding handles 4, 8 and tilting the pot 2 with any of the drainage devices 3 pointing downwards. The cooking pot 1 is thus in its position for drainage (FIG. 1). This position may also be used for cooking, whereby the holes function as a steam valve.

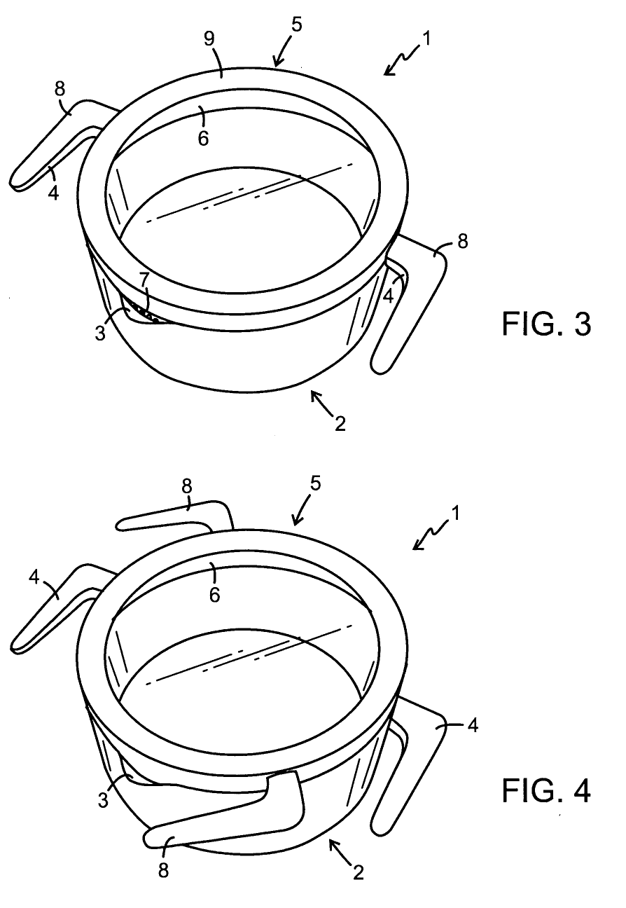

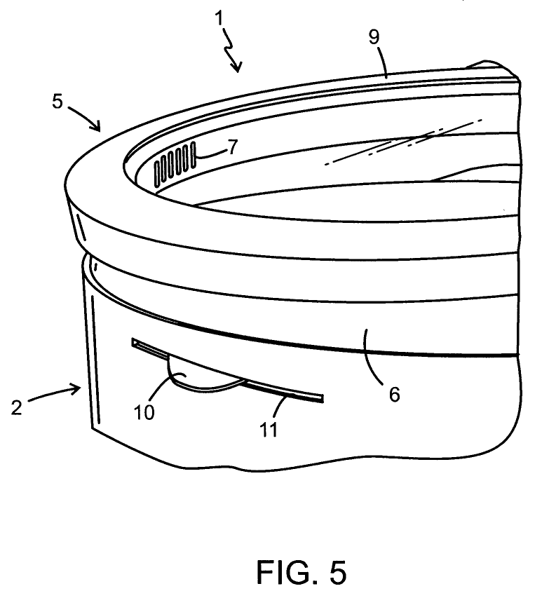

In FIG. 2 the same cooking pot 1 is shown with the cover 5 turned in relation to the pot 2, so that the areas with the radially arranged through holes 7 are prevented from communicating with the environment by way of the inner wall of the pot 2 closing the holes 7. The cooking pot 1 is thus in its boiling position (FIG. 2).

FIGS. 3 and 4 show a second embodiment of a cooking pot according to the invention.

FIG. 3 shows a cooking pot 1 comprising a pot 2 with a circular horizontal cross section and a drainage device 3 in the form of a spout. A second identical drainage device is arranged on the opposite side of the pot, but is not shown in the figure. On the outside of the cooking pot two handles 4 are arranged on opposite sides of the periphery of the pot, displaced around 90° along the periphery of the pot 2, in relation to drainage device 3 of the pot. The cooking pot 1 moreover comprises a cover 5 comprising a perpendicular, annular flange 6, the diameter of which is slightly less than the inner diameter of the pot 2, and which is intended to be arranged revolving coaxially within the periphery of the pot 1. On the upper side of the flange 6 a covering part 9 is arranged, the diameter of which surpasses the diameter of the pot 2, so that it when the cover 5 is localized on the pot 2, is with its lower side resting on the upper edge of the pot 2. The flange 6 within an area exhibits several radially arranged through holes 7. On the opposite side of the periphery of the flange 6 there is likewise arranged an identical area with several radially arranged through holes. On the shell surface of the cover part 9 two handles 8 are arranged on opposite sides of the periphery of the cover part 9, in a position which is displaced around 90° from the area with the through holes 7.

The area with the radially arranged through holes 7 on the flange 6 is arranged so that, when the cover 5 is arranged on the pot 2 and the cover 5 is turned in relation to the pot 2, so that the handle 8 on the pot 2 and the handle 4 on the pot 2 coincide, the area with the radially arranged through holes 7 coincides with the position of the drainage device 3. It is now possible to decant the fluid in the pot 2 through the radially arranged through holes without losing the solid substance in the pot 2, by taking hold of the two pairs of coinciding handles 4, 8 and tilting the pot 2 with one of the drainage devices 3 pointing downwards. The cooking pot 1 is thus in its drainage position (FIG. 1).

In FIG. 4 the same cooking pot 1 is shown with the cover 5 turned in relation to the pot 2, so that the area with the radially arranged through holes 7 is prevented from communicating with the environment by way of the inner wall of the pot 2 closing the holes 7. The cooking pot 1 is thus in its boiling position (FIG. 2).

As is shown in FIG. 3, the flange 6 is fitted with a locking lip 10 which stretches radially outward. This locking lip 10 is intended to interact with a slot 11 in the periphery of the pot 2 and is still a hindrance against the cover falling off in connection with the pot 2 being tilted for decanting fluid. In order to be able to place the cover on the pot the locking lip 10 must consequently be inserted in the slot 11. The peripheral extension of the slot 11 is at least large enough to allow the cover 4 to be turned between the boiling position and the drainage position.

The cover 5 may be variously designed. In the embodiments described above the radially speaking central part of the cover part is made out of a transparent material, for example toughened glass, which allows a clear insight into the pot during cooking and the like. Within the scope of the invention (but not shown) the cover may be fitted with a knob in the same manner as previously known covers for cooking pots. The drainage devices 3 in the pot 2 according to the embodiment in FIGS. 1 and 2 serve the purpose of being suitable for both left- or right-handed people. The cooking pots may instead have only one drainage device and thus be adapted to either right- or left-handed people. Moreover, the slot 11 may in its extension be designed so that it is possible to turn the cover from the drainage position to the boiling position, either clockwise or counter-clockwise, or in both directions. A possible embodiment of the invention may furthermore be devoid of the locking lip 10 and the slot 11. Small pots do not need this arrest to the same extent.

The foregoing is exemplifying embodiments of the current invention and the person skilled in the art realizes that modifications of these embodiments may be carried out without departing from the scope of the invention as defined by the accompanying claims.

1. (canceled)

2. (canceled)

3. (canceled)

4. (canceled)

5. A cooking pot comprising a circular, horizontal cross section, at least one drainage device, at least one handle attached to the outside of the pot, and a cover that comprises a perpendicular, annular flange, wherein the diameter of said cover is slightly less than the inner diameter of the pot and said flange is fitted with at least one radially arranged through-hole and at least one handle, wherein the through hole is arranged so that when the cover is on the pot, the peripheral position of the at least one through hole coincides with that of the drainage device when the peripheral positions of the handles on the pot and the cover coincide with each other in a drainage position, and the peripheral position of the at least one through hole does not coincide with that of the drainage device when the peripheral positions of the handles on the pot and the cover do not coincide with each other in a boiling position, and wherein the handles on the pot are a pair arranged on opposite sides of the periphery of the pot and that the handles on the cover are two handles arranged on opposite sides of the periphery of the cover part.

6. The cooking pot according to claim 5, wherein the handles are displaced around 90° along the periphery of the pot, in relation to drainage device and the area with the at least one through hole, respectively.

7. The cooking pot according to claim 5, wherein the flange is fitted with a locking lip, which stretches radially outward and is configured to interact with a slot in the periphery of the pot, wherein the peripheral extension of the slot is at least large enough to allow the cover to be turned between the boiling position and the drainage position.

8. The cooking pot according to claim 6, wherein the flange is fitted with a locking lip, which stretches radially outward and is configured to interact with a slot in the periphery of the pot, wherein the peripheral extension of the slot is at least large enough to allow the cover to be turned between the boiling position and the drainage position.

9. The cooking pot according to claim 5, wherein the pot is fitted with two drainage devices arranged on opposite sides of the periphery of the pot and, wherein the flange is fitted with at least one through hole on opposite sides of the flange.

10. The cooking pot according to claim 6, wherein the pot is fitted with two drainage devices arranged on opposite sides of the periphery of the pot and, wherein the flange is fitted with at least one through hole on opposite sides of the flange.

11. The cooking pot according to claim 7, wherein the pot is fitted with two drainage devices arranged on opposite sides of the periphery of the pot and, wherein the flange is fitted with at least one through hole on opposite sides of the flange.

12. The cooking pot according to claim 8, wherein the pot is fitted with two drainage devices arranged on opposite sides of the periphery of the pot and, wherein the flange is fitted with at least one through hole on opposite sides of the flange.
